(19) United States
(12) Patent Application Publication
(10) Pub. No.: US 2002/0067075 A1
(43) Pub. Date: Jun. 6, 2002

(54) Removable tracks for vehicle

(76) Inventors: Thomas Lee Wooten, Mobile, AL (US); Timothy Lee Wooten, Theodore, AL (US)

Correspondence Address: GREGORY M. FRIEDLANDER, 11 SOUTH FLORIDA STREET, MOBILE, AL, 36606-1934, US

(21) Appl. No.: 10/011,586

(22) Filed: Oct. 30, 2001

Related U.S. Application Data
(60) Provisional application No. 60/244,313, filed on Oct. 30, 2000.

(51) Int. Cl. B62D 55/26

(52) U.S. Cl. 305/185

(57) ABSTRACT

The invention comprises a series of U-shaped tracks loadable by way of a loading bar and chain through the inspection part opening onto the tires of a vehicle. The removable tracks are joined on either side by chains and have at least one aligning bar which keeps the treads centered on the tire by virtue of pressure placed on at least one side of the tire. The loading bar is also a part of the invention which holds the first or second lead track to the tire rim to help load and maintain the position of the tracks on the tire. The tracks also comprise a means for taking slack out of the spacing between the serially joined tracks.

### PRIORITY

This patent claims priority based on Provisional Patent No.: 60/244,313 filed Oct. 30, 2000.

### BACKGROUND OF INVENTION

1. Field of Invention

The present invention applies to tractor treads. More particularly the invention applies to a removable set of treads which may be loaded onto a vehicle having either one or one pair of tires on either side of an axle.

2. Prior Art

While tractor treads or caterpillar treads are well known in the prior art, the prior art fails to provide an adequate method for utilizing this type of tread mechanism on a vehicle where the vehicle primarily requires tire treads.

### GENERAL DISCUSSION OF INVENTION

Often times while a vehicle has excellent capabilities of moving itself over terrain, in order to haul sufficiently heavy loads through high angles or through particularly rough or muddy conditions caterpillar treads are necessary.

Examples of this are in the movement of heavy artillery, mobile homes, logging operations, and the like.

Most vehicles utilized for these type of operations have twin wheels on either side of an axle so that there is a left set of twin wheels and a right side of twin wheels. Often times there are front and rear left and right twin wheels.

The primary problem with temporary treads lies in the loading of those treads.

A fairly complex undertaking is necessary in order to load treads of the snow tire variety onto vehicles and typically these are inadequate in height and depth in order to provide traction in every situation.

Also the type of alignment mechanisms present in the prior art are inadequate in order to maintain the alignment of a set of treads without slipping or causing damage to the tires.

It is therefore an object of the invention to provide a high strength removable set of tracks fixably attached to a tire.

It is a further object of the invention to provide a mechanism for attaching a set of tracks to the inspection port of a tire rim.

It is a further object to provide heavy treads which may be easily loaded or removed from a non-treaded vehicle.

These and other objects and advantages of the invention will become better understood hereinafter from a consideration of the specification with reference to the accompanying drawings forming part thereof, and in which like numerals correspond to parts throughout the several views of the invention.

### BRIEF DESCRIPTION OF DRAWINGS

For a further understanding of the nature and objects of the present invention, reference should be made to the following detailed description taken in conjunction with the accompanying drawings in which like parts are given like reference numerals and wherein:

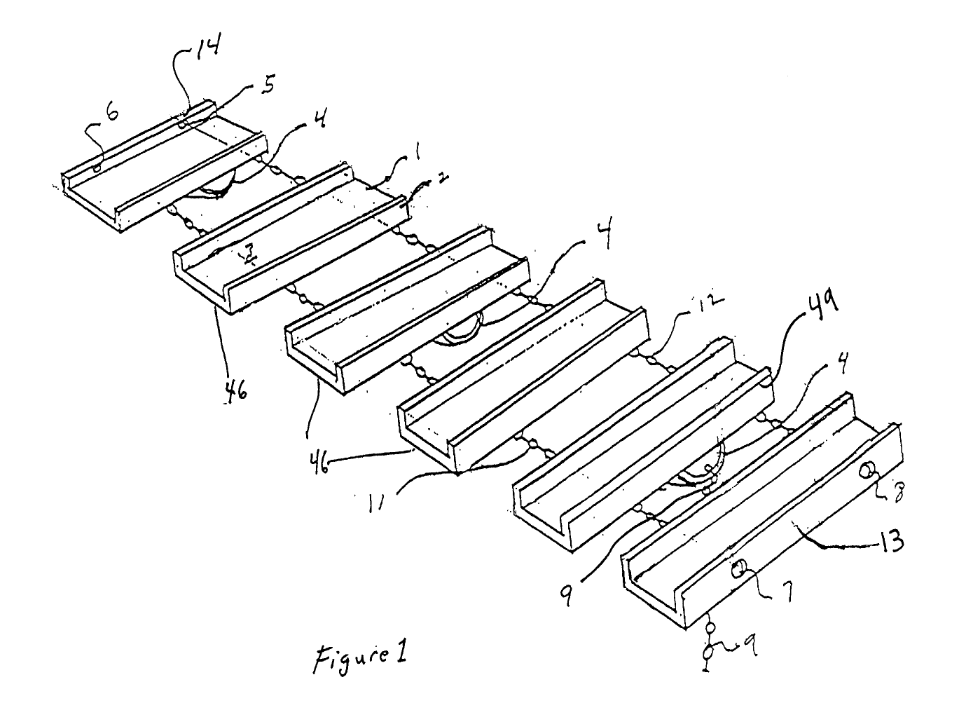

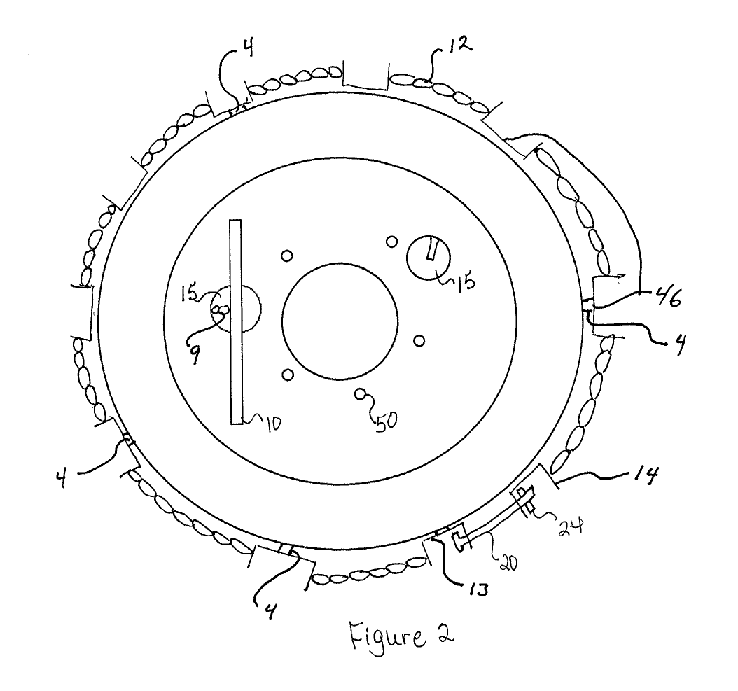

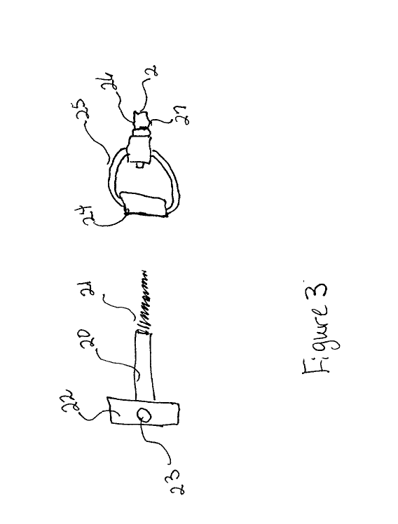

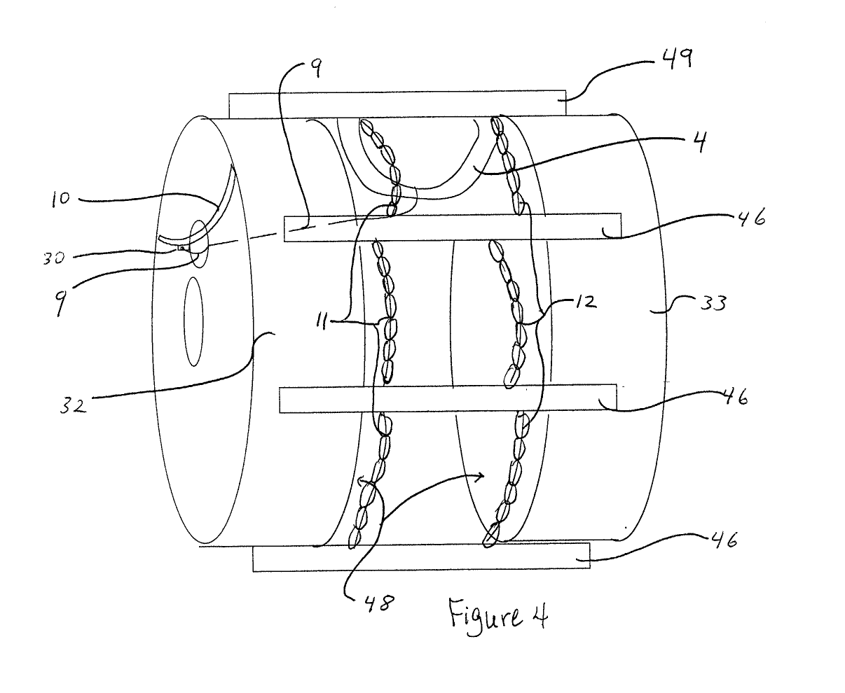

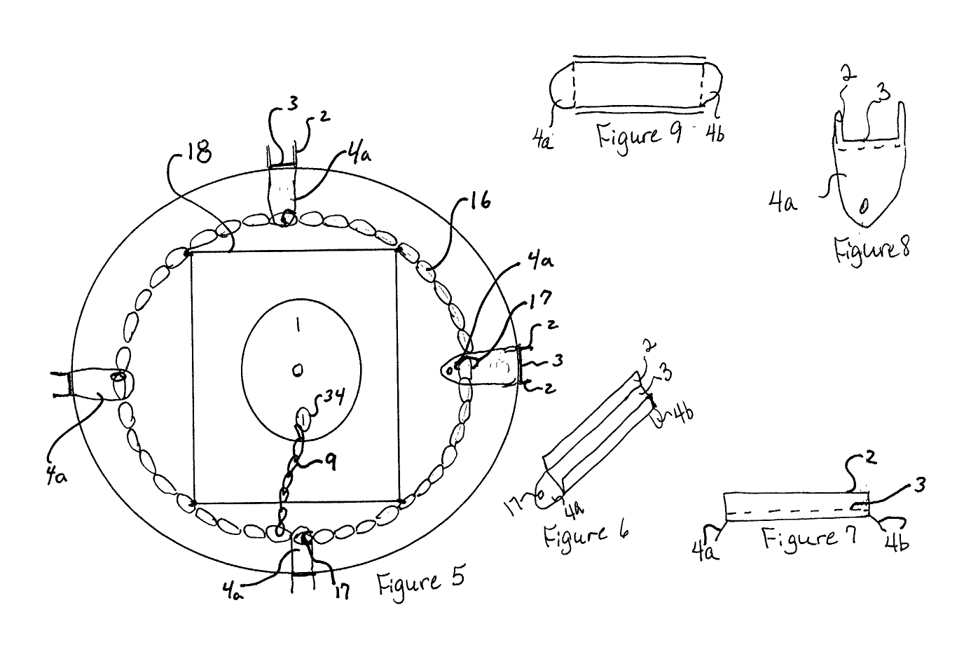

1. FIG. 1 is a perspective view of the tracks.

2. FIG. 2 is a side view of the tracks on a vehicle.

3. FIG. 3 is a detail of a bolt and nut.

4. FIG. 4 is a top view of tires of the invention.

5. FIG. 4 is a perspective view of the invention.

6. FIG. 5 is a side view of an alternate embodiment

7. FIG. 6 is a detail view of a wheel tread.

8. FIG. 7 is a side view of a wheel tread.

9. FIG. 8 is a short view of a wheel tread.

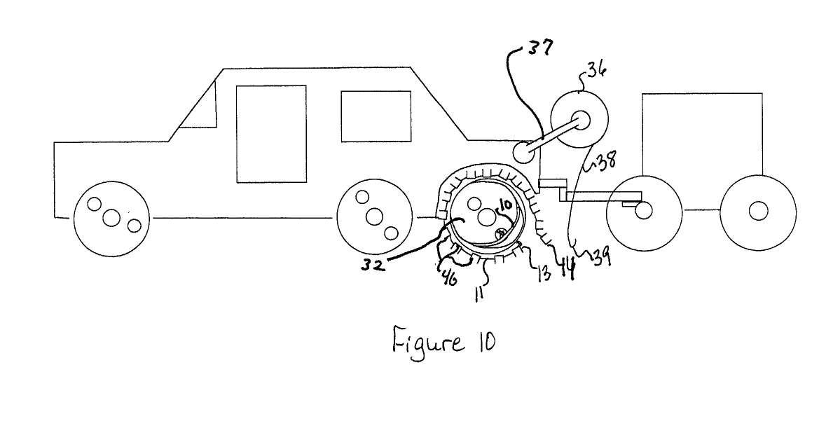

10. FIG. 9 is a top view of a wheel tread.

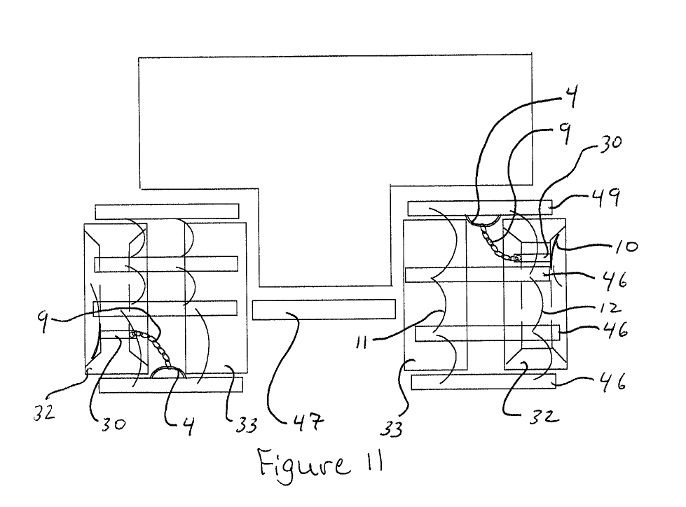

11. FIG. 10 is a detail of a vehicle having the treads in place and showing a reel.

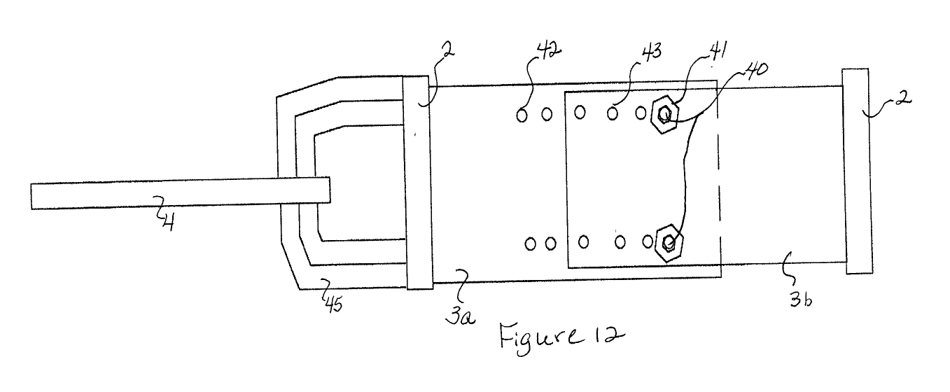

12. FIG. 11 is a top view of tires loaded with tracks.

13. FIG. 12 is a top view of a special track for joining the two sides of the track.

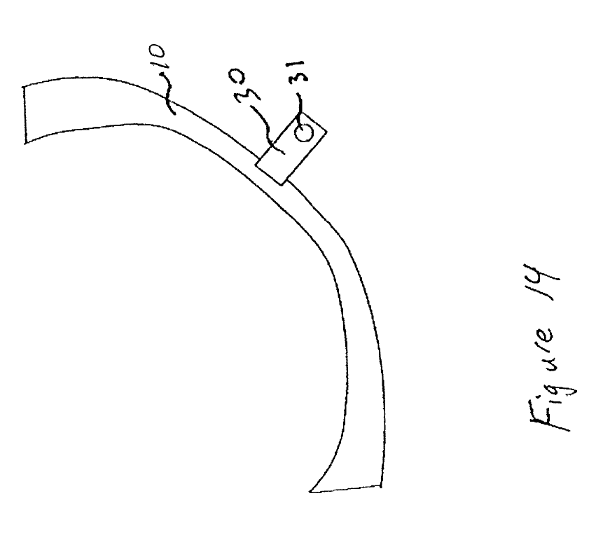

14. FIG. 14 is a detail view of one embodiment of the loading bar.

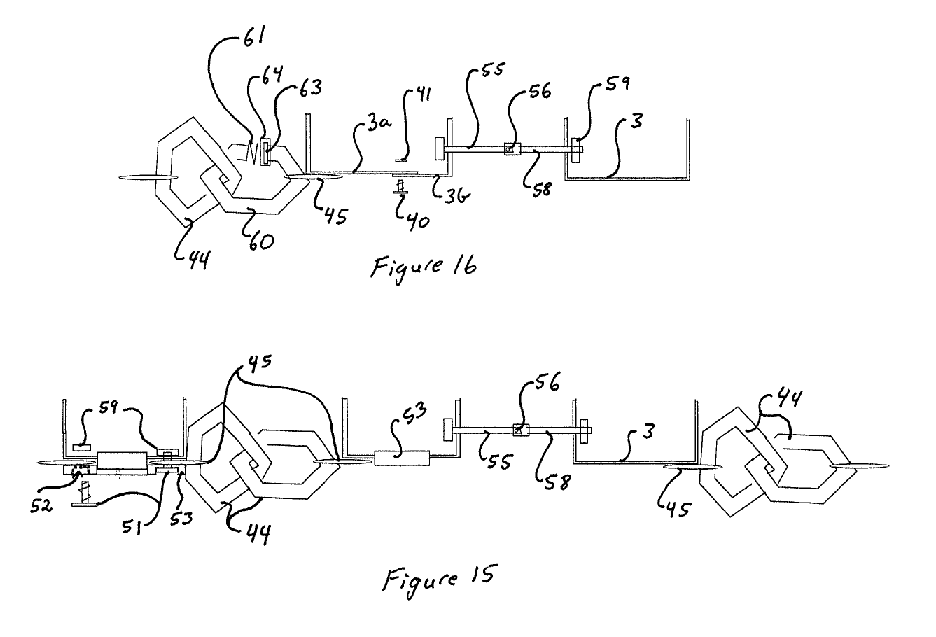

15. FIG. 15 is a side view of two tracks joined.

16. FIG. 16 is a side view of an alternate length adjusting mechanism.

### DETAILED DESCRIPTION OF PREFERRED EXEMPLARY EMBODIMENTS

As can best be seen by reference FIG. 1 the invention comprises a series of treads 1 comprised of a surface 3 having walls 2 on either side.

The loading end 13 has a chain 9 attached which is attached to a loading bar 10.

In the middle of every other tread, in the preferred embodiment, is a curved centering bar 4. This centering bar 4 may also be padded for the purposes of preventing damage to the tire or as shown in alternative embodiments two bars 4a and 4b may be placed on either side of a single tire as a left centering bar 4a and a right centering bar 4b as described in more detail below with reference to FIGS. 5-9.

The loading end first track 13 also has a left securing hole 7 and a right securing hole 8 which are aligned when the tracks are loaded with the left securing hole 6 and right securing hole 5 of the last track 14. The holes 7 and 8 are aligned with the holes 6 and 5 respectively when the tracks are fully loaded on the vehicle so that a bolts 20 may be driven through the holes and locked in place with a nut 24 in order to secure the treads together. While a bolt 20 is used in the preferred embodiment, chains or other connecting means may be used. One of the purposes of utilizing a bolt is so that the space between the outer face 13a and facing the outer face 14a is a gap between those which is not completely closed by securing means, in this case a bolt 20 and nut 24. As the bolt 20 and nut 24 are tightened the gap is reduced, tightly mounting the tracks in place on the vehicle tire tread surface.

A more flexible tightening mechanism might utilize a chain between two ends of a bolt in order to add some flexibility to the attachment. FIG. 3 shows where the bolt 20 and nut 24 are designed to be connected to chains through openings 23 and 28 respectively in the head 22 of bolt 20 and through a swivel bolt 27 attached to the nut 24 by arms 25 on the swivel barrel 26. This adds greater flexibility where the nut and bolt join the tracks.

Each of the tracks is connected to the next track on the left side by a left chain 11 and on the right side by a right chain 12 in order to keep them properly aligned.

As can best be seen by reference to FIG. 2, a typical tire well in which this device would be used includes lug nut holes 50 which go over lug nuts (not shown) and are secured by lug nut bolts (not shown).

Rim inspection openings 15 are also in place which are access holes in place in large tires on commercial vehicles and vehicles utilizing large rims for inspection and a variety of other purposes.

For the track to be loaded onto the vehicle, the chains are put behind the tire onto which they are to be loaded. The loading bar 10 is inserted from the inside of a double row of tires into the outside rim through opening 15. As the tire rotates this forces the track to be loaded onto the tire and keeps the track centered. FIG. 14 shows a detail of just the loading bar 10. This bar 10 has an attachment plate 30 defining a hole 31 which may receive the chain 9.

This chain 9 is typically connected to the first track 13 or the second track 49 from the front track 13 (as shown in FIG. 1) to minimize the pulling and free up the movement of the first track 13. As the tires turn, the track is automatically loaded onto the vehicle whether the vehicle moves over the treads or whether the treads are pulled onto the tire.

In this way even if the vehicle held fast by a load, the tracks may be loaded onto the vehicle as long as a space may be dug out to a rim hole here, inspection opening 15. The bar 10 may be bent (as shown in FIG. 14) to fit against the inside of the curving rim as shown in FIG. 10 or 12 (different bends). In this embodiment the bar 10 has a chain attachment plate 30 which fits through the opening 15 as the tracks are tightened so that a chain link is not affected.

The securing rod 10 may also be padded as the well as the chains (for the securing rod or connecting tracks) in order to further protect the vehicle and the tires. Similarly the tracks may also be rubberized or otherwise padded in order to protect the vehicle.

As can be seen by reference to FIG. 4 when in place the curved outer wall of the centering bar 4 contacts the facing surfaces 48 of the first twin tire (the inside tire 33) and second twin tire (outside tire 32) in order to keep the device centered.

As can best be seen by reference to FIGS. 5 through 9 a left centering bar 4a and a right centering bar 4b that can be utilized in order to keep the device centered in a similar way (preferably with curved surfaces) when only used on one tire. In this embodiment, a chain 16 may be run through eye holes 17 in bars 4a and 4b which chain 16 may be tightened by elastic webs 18. This is particularly useful where it is necessary to load the device without the benefit of a loading bar 10.

In order to accomplish this loading, the device may have the loading chain 9 attached to a loading nut 34 which nut 34 goes in place on one or more of the lug nuts of a typical vehicle in order to hold the loading chain 9 in place where an opening 15 is not available. In this event the chain 9 would run to one or more of the lug nuts from the outer centering bar 4a.

The loading nut 34 could be designed in such a way so that it would not need to be removed during use and would further serve to secure the position of the tracks. This is typically not desirable given the fact that some rotation in the tread might occur in the movement of heavy loads and typical lug bolts are unable to sustain this amount of tension for an extended period of time.

A reel 36 supported on arms 37 as shown in FIG. 10 may be provided on the back of the vehicle in order to lift these particularly heavy tracks 1 and a line 38 from the reel 36 on the left and right side may attach to the treads by way of a hook 39 into the left or right opening 6 and 5 (or both) in order to reel the tracks 1 up from the ground or in order to unreel tracks 1 so that they need not be lifted by hand.

As these are fairly heavy pieces of equipment being typically made of ¾″×½″ channel iron or aluminum alloy in the preferred embodiment, a mechanism for loading these onto the tires is helpful.

A set of tracks 1 might have 3 inch high walls 2 and be 20 inches long from one side to the other. In the preferred embodiment, the tracks have 1 ⅜ inches high walls 2 and are 3 inches wide and 20 inches long. In the middle, the centering bar 4 is made from a three inch pipe cut in half. The chains 11 and 12 are typically 7 inches with one inch on either side being welded to the tread. It is preferably 3/16 inch chain in the preferred embodiment. Some tolerance is allowed, although the dimensions must be within two inches to function well.

FIG. 11 shows a back view showing how two sets of tracks 1 may be attached to two sets of two rear tires. The chain 9 from each second track 49 is shown running to the centering bar 4 and to loading bar 10.

FIG. 12 shows another method of eliminating slack or adding length. In this embodiment, at least one of the tracks is separated onto a left piece 3a and a right piece 3b held together with one or more tread bolts 40 secured by nuts 41 (here two bolts 40 to maintain alignment). Rows of bolt holes 42 along the length of the left piece 3a align with rows of holes 43 in the right piece 3b of the track surface 3 so that the width of the track may be changed. This also provides a method of adding or removing tracks. It may be used with, or in place of a connecting bolt 20 between two separate tracks 13 and 14.

FIG. 12 also shows how the lead link 45 is made as a part (by weld or casting) of the tread 3a and has one or more following links 44.

The front link, lead link 45, may be welded to the surface 3 and hold link nut 60 so that slack may be taken up.

FIG. 15 shows a bolt 51 fitting into a recess 52 in a part 53 and secured with a nut 59 to secure the lead link 45 to the track.

FIG. 16 shows how a special bolt with some flexibility may join the first track 13 and last track 14. This bolt 54 has a left side 55 connected at a pivot 56 to the right side 58 which is held by nut 59. Two such bolts may typically be used to provide better connectivity between the first and last tracks.

Because different lengths tread and chain are necessary for different sized vehicles, the tracks may be designed so that links and treads may be removed in other ways. One alternate shown in FIG. 15 is to have closeable C clamps 60 (FIG. 16) in place of one or more of the chain links to allow for easy adjustment of the length. This also allows for links and treads to be removed if that becomes necessary for any number of reasons such as tire deflation, different sized vehicle tires stretching or fitting of chains which are not adequately taken up by the bolt and nut configuration.

FIG. 16 shows a C-clamp used with the invention. FIG. 16 shows how a link may be a C-clamp 60 with a nut 64 rotating around a bracket 63 to screw onto a threaded portion 61 of the C-clamp so that it may be removed or added to chain links 65 or the lead link 45:

Because many varying and different embodiments may be made within the scope of the inventive concept herein taught and because many modifications may be made in the embodiment(s) herein detailed in accordance with the descriptive requirements of the law, it is to be understood that the details herein are to be interpreted as illustrative and not in a limiting sense.

1. A removable track system for a vehicle having a tire with a rim, a left and right side, a tread face, and a rim defining an inspection opening comprising:
(a) a plurality of tracks comprised of a first track and at least one middle track and a last track said tracks having a left side, a right side and a middle;
(b) a joining means for flexibly joining the first track to the at least one middle track and the at least one middle track to the at least one last track;
(c) an attaching means for attaching at least one track to the tire left side so as to fix the track relative to the tire;
(d) an attaching means for attaching the first track to the last track and for tightening the tracks against the tire tread face.

2. The invention of claim 1 wherein the joining means comprises a chain.

3. The invention of claim 1 wherein the joining means comprises a steel cable.

4. The invention of claim 1 wherein the tracks are metal tracks having a surface and at least one wall rising at least one inch from the surface away from the tread faces when the tracks are attached to a tire.

5. The invention of claim 1 wherein the attaching means comprises a metal bar flexibly connected to at least one of the tracks and attachable to the tire rim.

6. The invention of claim 5 wherein the attaching means is attachable to the tire rim by fitting the metal bar through the inspection plate opening to contact the rim.

7. The invention of claim 1 wherein the invention further comprises a first centering bar extending from the left side of at least one track and contacting the left side of the tire.

8. The invention of claim 7 further comprising a second centering bar extending from the right side of the at least one track and contacting the right side of the tire.

9. The invention of claim 1 wherein the invention is to be used on a vehicle with two tires beside one another with facing sides creating a space between the facing sides and wherein the centering bar runs from the left side to the right side with the at least one track so as to occupy the space between the facing sides of the tires.

10. The invention of claim one wherein the tracks further comprise a metal middle and comprise at least one non metallic pad between the metal middle and tire when loaded onto a tire.

11. The invention of claim 1 further comprising a tightening means for taking slack out of the plurality of treads once they are on the tire.

12. The invention of claim 11 wherein the attaching means comprises a bolt extending from the first track into a nut in the last track.

13. The invention of claim 12 wherein the bolt is flexible.

14. The invention of claim one wherein the distance between the first track and last track is approximately the same as the distance around the tire.

15. The invention of claim 1 further comprising a reel on the vehicle for gathering or releasing the tracks.

16. The invention of claim 15 wherein the reel comprise a line with a hook for attaching the tracks.

17. The invention of claim 1 wherein the joining means comprises a plurality of interconnected chain links.

18. The invention of claim 17 wherein at least one of the plurality of chain links may be opened to connect to any of the remaining chain links.

19. The invention of chain 11 wherein the attaching means comprises a first plate defining a series of connecting holes attached to the first track and a second plate defining a second group of connecting holes attached to the first track and at least one bolt means for joining the first plate to the second plate by passing through at least one hole on the first plate and one hole in the second plate.

20. A method for pulling heavy loads on a vehicle having from claim 1 comprising the steps of:
(a) inserting a gripping means through the inspection hole;
(b) attaching the gripping means to one of a plurality of serially connected tracks;
(c) loading the tracks onto the tire perimeter;
(d) fixing the tracks around the tire perimeter of the tire.
